(19) United States
(12) Patent Application Publication
(10) Pub. No.: US 2025/0303617 A1
(43) Pub. Date: Oct. 2, 2025

(54) MOULD ASSEMBLY, OPTICAL COMPONENT AND USING METHOD OF MOULD ASSEMBLY

(71) Applicants: Asphetek Solution (Chengdu) Ltd., Chengdu (CN); Asphetek Solution Inc., Hsinchu (TW)

(72) Inventors: HSIANG TSAI, Hsinchu (TW); CHUNG-WU LIU, Hsinchu (TW); YU-PI KUO, Hsinchu (TW)

(21) Appl. No.: 18/736,455

(22) Filed: Jun. 6, 2024

(30) Foreign Application Priority Data
Mar. 27, 2024 (CN) 202410354194.9

(51) Int. Cl. B29C 43/02; B29C 43/00; B29C 43/36; B29C 43/52; B29K 33/00; B29K 105/00; B29L 11/00; G02B 5/18

(52) U.S. Cl. CPC B29C 43/021; B29C 43/36; B29C 43/52; G02B 5/1852; B29C 2043/023; B29K 2096/00; B29K 2105/0088; B29K 2995/0031; B29K 2995/0094; B29L 2011/0016; G02B 1/118

(57) ABSTRACT

A mould assembly is provided, comprising an upper mould and a lower mould, a release film is provided between the upper mould and the lower mould, the lower mould defines a cavity for processing a workpiece, the release film covers the cavity, a bottom surface of the cavity provides an exhaust area, the exhaust area defines a plurality of exhaust grooves, the lower mould defines one or more through-holes, the plurality of exhaust grooves is communicated with one or more through-holes, a width of the plurality of exhaust grooves is less than a width of the release film, one or more through-holes draw the air to make the release film attach on the bottom surface of the cavity.

### FIELD

The present disclosure relates to field of mould assembly technology, particularly to a mould assembly, an optical component and using method of the mould assembly.

### BACKGROUND

A Brightness Enhancement Film (BEF), also known as a prism or condenser, is a key component in a backlight module. A function of the BEF deflects the light to a front angle of view and has a light collection incremental effect, the BEF is often used in displays to provide higher brightness gain and generally can improve about 60% to 100% of the increasing in brightness. A BEF processed by a traditional handicraft is flat.

In an existing optical component, a lens of the optical component is a curved surface, and it is necessary to use a surface coating technology to fit the plane BEF on the curved lens. Due to an insufficient ductility of the brightening film, the existing mould cannot fit the BEF tightly to the lens.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a schematic view of a mould assembly and a lens in an embodiment of the present disclosure.

FIG. 2 illustrates a schematic view of a first mould in FIG. 1.

FIG. 3 illustrates a schematic view of the lens in FIG. 2.

FIG. 4 illustrates a flow diagram of a using method of the mould assembly in an embodiment of the present disclosure.

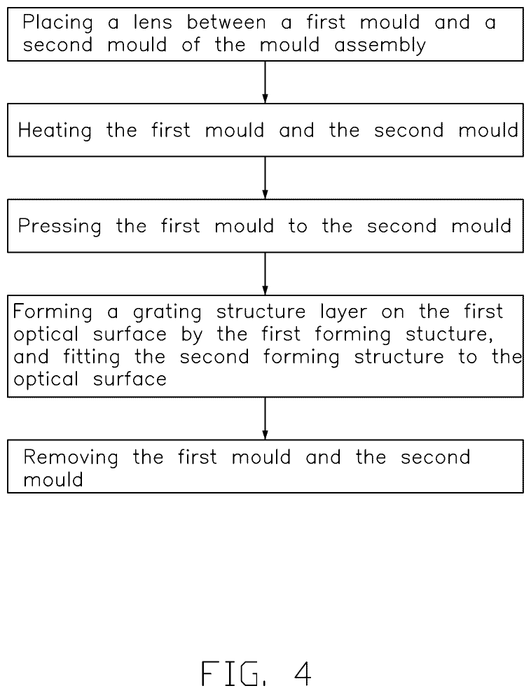

### DETAILED DESCRIPTION

In order to make the above-mentioned objects, features and advantages of the present application more obvious, a detailed description of specific embodiments of the present application will be described in detail with reference to the accompanying drawings. A number of details are set forth in the following description so as to fully understand the present application. However, the present application can be implemented in many other ways different from those described herein, and those skilled in the art can make similar improvements without violating the contents of the present application. Therefore, the present application is not to be considered as limiting the scope of the embodiments described herein.

Several definitions that apply throughout this disclosure will now be presented.

The term “coupled” is defined as coupled, whether directly or indirectly through intervening components, and is not necessarily limited to physical connections. The connection may be such that the objects are permanently coupled or releasably coupled. The term “substantially” is defined to be essentially conforming to the particular dimension, shape, or other feature that the term modifies, such that the component need not have that exact feature. The term “comprising,” when utilized, means “including, but not necessarily limited to”; it specifically indicates open-ended inclusion or membership in the so-described combination, group, series, and the like.

Unless otherwise defined, all technical and scientific terms used herein have the same meaning as commonly understood by one skilled in the art. The terms used in a specification of the present application herein are only for describing specific embodiments and are not intended to limit the present application. The terms “and/or” used herein comprises any and all combinations of one or more of associated listed items.

Some embodiments of the present application are described in detail. In the case of no conflict, the following embodiments and the features in the embodiments can be combined with each other.

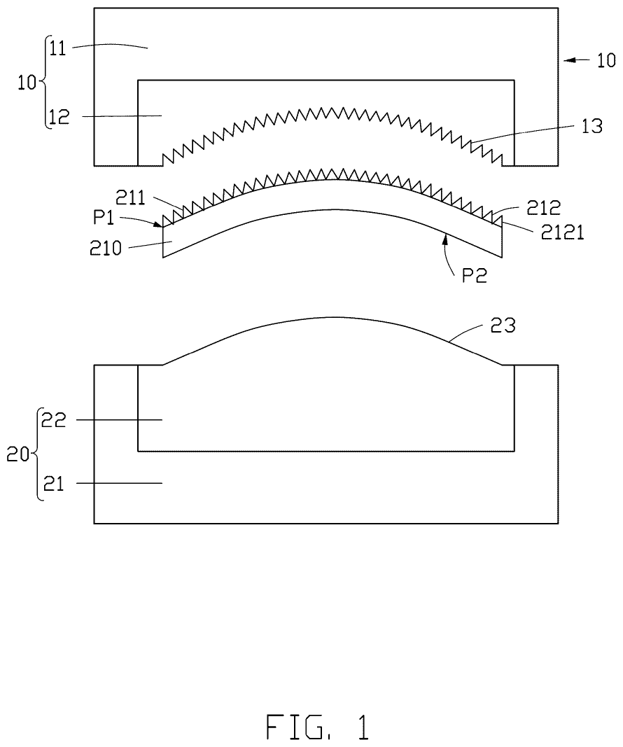

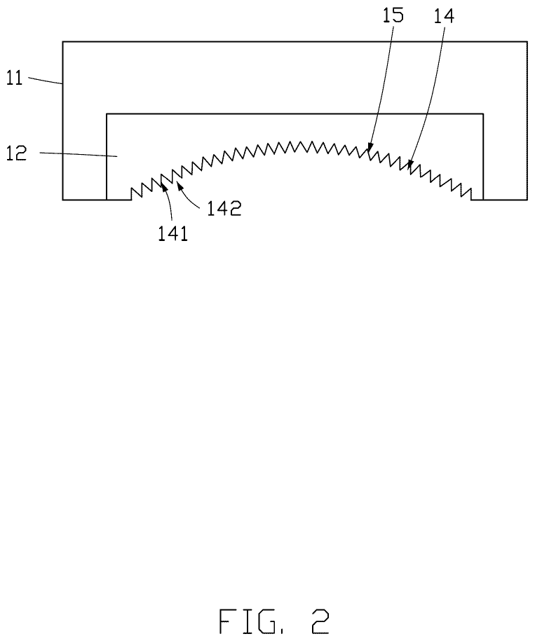

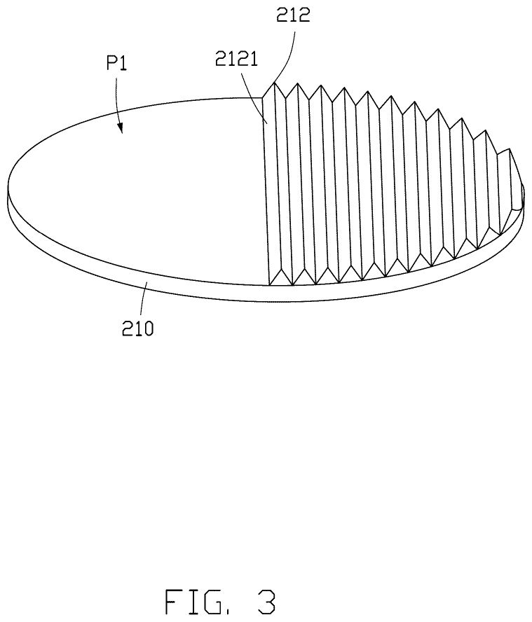

Referring to FIG. 1, FIG. 2, and FIG. 3, illustrate a mould assembly 100 according to an embodiment of the present application. The mould assembly 100 can be used for manufacturing an optical component 200. The mould assembly 100 includes a first mould 10 and a second mould 20. The first mould 10 and the second mould 20 are relatively arranged. The first mould 10 includes a first seat 11 and a first kernel 12, the first seat 11 and the first kernel 12 are relatively arranged, the first seat 11 is connected to the first kernel 12. The second mould 20 includes a second seat 21 and a second kernel 22, the second seat 21 and the second kernel 22 are relatively arranged, the second seat 21 is connected to the second kernel 22, the first kernel 12 is located on a side adjacent to the second kernel 22.

The optical component 200 includes a lens 210, the lens 210 is provided a first optical surface P1 and a second optical surface P2, a side of the first mould 10 toward the second mould 20 is provided with a first forming structure 13, the first forming structure 13 is configured to form a grating structure layer 211 on the first optical surface P1, a side of the second mould 20 toward the first mould 10 is provided with a second forming structure 23, the second forming structure 23 is fit to the second optical surface P2. In the embodiment, when the grating structure layer 211 is formed on a surface of the lens 210, the lens 210 is placed between the first mould 10 and the second mould 20, the first optical surface P1 of the lens 210 is near the first mould 10 and the second optical surface P2 is near the second mould 20. When the first mould 10 and the second mould 20 are closed, the first forming structure 13 of the first mould 10 will be pressed to the first optical surface P1 under closing forces of the first mould 10 and the second mould 20, and the grating structure layer 211 is formed on the first optical surface P1. The second forming structure 23 is fit to the second optical surface P2 of the second mould 20 to position the lens 210.

In other embodiments, the first forming structure 13 can also be located on a side of the second mould 20 near the first mould 10, the second forming structure 23 is located on a side of the first mould 10 near the second mould 20. When the first mould 10 and the second mould 20 are closed, the grating structure layer 211 is formed on the second optical surface P2, the first optical surface P1 is fit to the second forming structure 23. The grating structure layer 211 can be formed on the first optical surface P1 of the lens 210 under the closing forces of the first mould 10 and the second mould 20, or the grating structure layer 211 can be formed on the second optical surface P2 of the lens 210 under the closing forces of the first mould 10 and the second mould 20. In another embodiment, the grating structure layer 211 can be simultaneously formed on the first optical surface P1 and the second optical surface P2.

In one embodiment, the first forming structure 13 includes a plurality of groove structures 14 and a plurality of raised structures 15. Each of the plurality of the groove structure 14 is adjacent to one of the plurality of raised structures 15. The plurality of the groove structures 14 and the plurality of the raised structures 15 are located on the side of the first mould 10 near the second mould 20.

In one embodiment, a shape of a cross section of each of the plurality of the groove structures 14 is a triangular shaped. For example, the shape of the cross section of the groove structure 14 can be an acute triangle, an obtuse triangle, a right triangle, an isosceles triangle, or an equilateral triangle. In other embodiments, the shape of the cross section of the groove structure 14 is a fan shaped.

In one embodiment, a shape of a cross section of each of the plurality of the raised structures 15 is a triangular shaped. For example, the shape of the cross section of the raised structure 15 can be an acute triangle, an obtuse triangle, a right triangle, an isosceles triangle, or an equilateral triangle. In other embodiments, the shape of the cross section of the raised structure 15 is a fan shaped.

Referring to FIG. 2, each of the plurality of the groove structures 14 includes a first groove 141 and a second groove 142, a distance between a bottom of the first groove 141 and a bottom of the second groove 142 is marked as a first distance, the first distance is in a range between 10 um-100 μm. For example, the first distance can be 12 μm, 20 um, 30 μm, 40 um, 50 μm, 60 μm, 70 μm, 80 um, or 90 um. Under an action of the first distance, the light can be reflected or refracted by the grafting structure layer 211 to improve a brightness of the optical component 200.

In one embodiment, a depth of each of the plurality of the groove structures 14 is in a range between 20 um-100 μm. For example, the depth of the plurality of the groove structures 14 can be 25 μm, 30 um, 40 μm, 40 um, 50 μm, 60 μm, 70 μm, 80 um, or 90 um. A first angle is formed between a bottom and a side of each of the plurality of the groove structures, the first angel can be an acute angle. For example, the first angle can be 15°, 30°, 45°, 55°, 60°, or 75°. When the first angle is an acute angle, the first angle makes the grating structure layer 211 formed on the first optical surface P1 reflect or refract light better. If the first depth is too large or too smaller, which may affect the reflection effect or refraction effect of the light in the grating structure layer 211.

In one embodiment, the depth of the first groove 141 is equal to a depth of the second groove 142, a diameter of the first groove 141 is equal to a diameter of the second groove 142.

In other embodiments, the depth of the first groove 141 is not equal to the depth of the second groove 142, the diameter of the first groove 141 is not equal to the diameter of the second groove 142.

In another embodiment, the depth of the first groove 141 is equal to the depth of the second groove 142, the diameter of the first groove 141 is not equal to the diameter of the second groove 142.

In yet embodiment, the depth of the first groove 141 is not equal to the depth of the second groove 142, the diameter of the first groove 141 is equal to the diameter of the second groove 142.

According to an actual demand of reflection or refraction of the light through the grating structure layer 211, the depth of the first groove 141 can be equal to the depth of the second groove 142 or the depth of the first groove 141 can be not equal to the depth of the second groove 142, and the diameter of the first groove 141 is equal to the diameter of the second groove 142 or the diameter of the first groove 141 is not equal to the diameter of the second groove 142.

In the mould assembly 100, the first mould 10 includes the plurality of groove structures 14 and the plurality of the raised structures 15. The shape of the cross section of each of the plurality of the groove structures 14 is a triangular shaped. When the first mould 10 and the second mould 20 are combined, the grating structure layer 211 is formed on the first optical surface P1 by the plurality of the groove structures 14 and the plurality of the raised structures 15. In order to ensure the brightness of the light passing through the grating structure layer 211, the distance between the bottom of the first groove 141 and the bottom of the second groove 142 can be set in the range of 10 um-100 μm, and the depth of the groove structures 14 can be set in the range of 20 um-100 um according to the actual optical requirements. The grating structure layer 211 can be formed directly on the surface of the lens 210, the technical problem that disclosure moulds cannot tightly fit the flat brightening film to the curved lens 210 is avoided.

Referring to FIG. 1 and FIG. 3, one embodiment of the present application discloses the optical component 200. The optical component 200 is made of the mould assembly 100. The optical component 200 includes the lens 210 and the grating structure layer 211, the grating structure layer 211 is located on a side of the lens 210, the lens 210 is provided the first optical surface P1, the grating structure layer 211 includes a plurality of pyramid units 212, the plurality of the pyramid units 212 is arranged on the first optical surface P1 in a predetermined direction.

In one embodiment, the plurality of the pyramid units 212 includes a first side 2121, an angle between the first side 2121 and a tangent line of the first optical surface P1 is in a range between 40°-120°. For example, the angle between the first side 2121 and the tangent line of the first optical surface P1 can be 45°, 50°, 60°, 70°, 80°, 90°, 100°, or 105°. The light is reflected or refracted by the grating structure layer 211 and reaches a display module of the optical component 200, the display module of the optical component 200 has a good brightness.

One embodiment of the present application discloses a using method of the mould assembly 100. The using method of the mould assembly 100 includes placing the lens 210 between the first mould 10 and the second mould 20 of the mould assembly 100, heating the first mould 10 and the second mould 20, pressing the first mould 10 to the second mould 20, forming the grating structure layer 211 on the first optical surface P1 by the first forming structure 13, fitting the second forming structure 23 to the second optical surface P2, and removing the first mould 10 and the second mould 20.

In one embodiment, a material of the lens 210 includes polyethylene naphthalene diformate and polyethylene glycol naphthalene diformate, a mass radio of the polyethylene naphthalene diformate is in a range between 43%-53%, a mass radio of the polyethylene glycol naphthalene diformate is in a range between 47%-57%, a temperature for heating the first mould 10 and the second mould 20 is in a range between 250° C.-300° C.

In another embodiment, a material of the lens 210 includes polyethylene glycol naphthalene dicarboxylate and polymethyl methacrylate, a mass ratio of the polymethyl methacrylate is in a range between 20%-30%, a mass ratio of the polyethylene glycol naphthalene dicarboxylate is in a range between 70%-80%, a temperature for heating the first mould 10 and the second mould 20 is in a range between 220° C.-300° C.

In another embodiment, a material of the lens 210 is 2-acrylic acid (1-a heartland of ethyl) 2 [(2, 6-dibromo-4, 1-phenylene) oxygen radicals (2-hydroxy-3, 1-propylene)] ester, a temperature for heating the first mould 10 and the second mould 20 is in a range between 25° C.-85° C.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A mould assembly applied to manufacture an optical component, the mould assembly comprising:
a first mould and a second mould, wherein the first mould and the second mould are relatively arranged, the optical component comprises a lens, the lens is provided a first optical surface and a second optical surface, a side of the first mould facing the second mould is provided with a first forming structure, the first forming structure is configured to form a grating structure layer on the first optical surface, a side of the second mould facing the first mould is provided with a second forming structure, the second forming structure is fit to the second optical surface.

2. The mould assembly as claimed in claim 1, wherein the first forming structure comprises a plurality of groove structures and a plurality of raised structures, and each of the plurality of the groove structure is adjacent to one of the plurality of raised structures.

3. The mould assembly as claimed in claim 2, wherein the plurality of the groove structures comprises a first groove and a second groove, a depth of the first groove is equal to a depth of the second groove, a diameter of the first groove is equal to a diameter of the second groove.

4. The mould assembly as claimed in claim 2, wherein the plurality of the groove structures comprises a first groove and a second groove, a depth of the first groove is not equal to a depth of the second groove, a diameter of the first groove is equal to a diameter of the second groove.

5. The mould assembly as claimed in claim 2, wherein the plurality of the groove structures comprises a first groove and a second groove, a depth of the first groove is equal to a depth of the second groove, a diameter of the first groove is not equal to a diameter of the second groove.

6. The mould assembly as claimed in claim 2, wherein a shape of a cross section of each of the plurality of the groove structures is a triangular shaped.

7. The mould assembly as claimed in claim 2, wherein the plurality of the groove structures comprises a first groove and a second groove, a distance between a bottom of the first groove and a bottom of the second groove is in a range between 10 um-100 um.

8. The mould assembly as claimed in claim 2, wherein a depth of each of the plurality of the groove structures is in a range between 20 um-100 um.

9. The mould assembly as claimed in claim 2, wherein a first angle is formed between a bottom and a side of each of the plurality of the groove structures, and the first angel is an acute angle.

10. An optical component manufactured by a mould assembly, the optical component comprising:
a lens and a grating structure layer, wherein the grating structure layer is located on a side of the lens, the lens is provided a first optical surface, the grating structure layer comprises a plurality of pyramid units, the plurality of the pyramid units is arranged on the first optical surface in a predetermined direction.

11. The optical component as claimed in claim 10, wherein each of the plurality of the pyramid units comprises a first side, an angle between the first side and a tangent line of the first optical surface is in a range between 40°-120°.

12. A using method of a mould assembly, the using method of the mould assembly comprising:
placing a lens between a first mould and a second mould of the mould assembly, wherein the lens is provided a first optical surface and a second optical surface, a side of the first mould facing the second mould is provided with a first forming structure, and a side of the second mould facing the first mould is provided with a second forming structure;
heating the first mould and the second mould;
pressing the first mould to the second mould;
forming a grating structure layer on the first optical surface by the first forming structure, and fitting the second forming structure to the second optical surface; and
removing the first mould and the second mould.

13. The using method of the mould assembly as claimed in claim 12, wherein a material of the lens comprises polyethylene naphthalene diformate and polyethylene glycol naphthalene diformate, a mass radio of the polyethylene naphthalene diformate is in a range between 43%-53%, a mass radio of the polyethylene glycol naphthalene diformate is in a range between 48%-57%, a temperature for heating the first and second die steps is in a range between 250° C.-300° C.

14. The using method of the mould assembly as claimed in claim 12, wherein a material of the lens comprises polyethylene glycol naphthalene dicarboxylate and polymethyl methacrylate, a mass ratio of the polymethyl methacrylate is in a range between 20%-30%, a mass ratio of the polyethylene glycol naphthalene dicarboxylate is in a range between 70%-80%, a temperature for heating the first and second die steps is in a range between 220° C.-300° C.

15. The using method of the mould assembly as claimed in claim 12, wherein a material of the lens is 2-acrylic acid (1-a heartland of ethyl) 2 [(2, 6-dibromo-4, 1-phenylene) oxygen radicals (2-hydroxy-3, 1-propylene)] ester, a temperature for heating the first and second die steps is in a range between 25° C.-85° C.
